(19) United States
(12) Patent Application Publication
(10) Pub. No.: US 2007/0198378 A1
(43) Pub. Date: Aug. 23, 2007

(54) MATCHED PAIRS INVESTMENT FUND SYSTEMS AND METHODS

(76) Inventor: LEONARD G. GORDON, LOS ANGELES, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 11/624,689

(22) Filed: Jan. 18, 2007

Related U.S. Application Data
(60) Provisional application No. 60/743,145, filed on Jan. 18, 2006.

(51) Int. Cl. G06Q 40/00

(52) U.S. Cl. 705/35

(57) ABSTRACT

Systems and methods for pairing investment capital with capital seeking entities including the steps of locating and establishing a relationship with a suitable paired growth company in need of capital, locating and establishing a relationship with a paired publicly traded company with available capital, establishing a fund for investing capital into the paired growth companies in need of capital, investing capital from the fund into the paired growth company, receiving equity from the paired growth company in exchange for the capital, holding in the fund an amount of the received equity in one or more freely tradeable shares of the paired publicly traded company which are listed on a public stock exchange. The publicly traded company can be paired with the paired growth company so that the paired growth company has access to the capital markets through the shares of the publicly traded company.

### CROSS-REFERENCES TO RELATED APPLICATIONS

This application claims priority to U.S. provisional application Ser. No. 60/743,145 to the same inventor filed on Jan. 18, 2006 which is incorporated herein by reference in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND

1. Field

Embodiments of the claimed subject matter relate to novel methods and systems for raising funds in capital markets that can be used by companies in need of working capital as well as management assistance and management of relationships between investors and the companies being funded.

2. Background

During the past few years, the complex wants and needs of China Companies attempting to work with USA Companies have been growing. The embodiments of the systems and methods of matched pairs sprung from the recognition that the need for access to capital for growth could be met while at the same time avoiding traditional problems associated with foreign investment. A basic lesson was learned from observing the Shanghai Stock Exchange's missed opportunities that was apparent during the period, 2002 through 2004. The marketplace excitement that greeted the suddenly active community of smaller and less stable companies eventually got out of hand and, in-turn, misused investor confidence. What initially began to replace the then-shrinking confidence was excessive caution on the part of both the regulators and the investing public, which in-turn greatly reduced the amounts of capital available to even the strongest China based companies.

It has become desirable for Chinese companies to “go public” on foreign stock exchanges, such as the USA's NASDAQ exchange. Examples of companies that could benefit from the availability of public investment include science and technology companies that were involved in the health care sector; and those companies active in the perfecting of natural, botanically-derived, pharmaceuticals, those in pharmacologically-powerful neutraceuticals and a few highly-regarded ancient herbal formulations. Matched investor partners in the United States and elsewhere with similar interests in the field make foreign capital investments in these small and medium sized China-domiciled corporations. Additionally, the administrator may have an in-depth knowledge of the field or fields that are pertinent and specific to the investment being made and within which they are interacting.

### SUMMARY OF THE INVENTION

Embodiments of the disclosed systems and methods involve a business concept of matching more than one company, such as a USA company and a China company, so that the two or more companies can synergistically work together using the strengths of each company to work together towards a common goal.

Embodiments include systems and methods for pairing investment capital with entities in need of capital including the steps of locating and establishing a relationship with a suitable paired growth company in need of capital, locating and establishing a relationship with a paired publicly traded company with available capital, establishing a fund for investing capital into the paired growth companies in need of capital, investing capital from the fund into the paired growth company, receiving equity from the paired growth company in exchange for the capital, holding in the fund an amount of the received equity in one or more freely tradeable shares of the paired publicly traded company which are listed on a public stock exchange. The publicly traded company is paired with the paired growth company so that the paired growth company has access to the capital markets through the shares of the publicly traded company which are listed on one or more public exchanges.

Another embodiment further includes the step of merging the paired publicly traded company with the paired growth company into a single entity with shares listed on one or more public exchanges.

Another embodiment further includes the step of managing the business relationship between the paired publicly traded company and the paired growth company so that the efficiencies of the tactical legal and economic relationships between maximized.

Yet another embodiment further adjusts the investment by the appreciation or depreciation of one or more foreign currencies, and another embodiment further adjusts the investment by the appreciation or depreciation of the value of the one or more equity stocks.

### BRIEF DESCRIPTION OF THE DRAWINGS

Not. Applicable.

### DETAILED DESCRIPTION OF THE EMBODIMENTS

Embodiments of the claimed methods and systems provide services to both investors and to certain entities requiring access to capital for growth. In the following description, numerous specific details are set forth, such as transactions performed in the context of investment and management activities, to provide a thorough understanding of the various embodiments of the claimed subject matter. One skilled in the relevant art will recognize, however, that these embodiments can be practiced without one or more of the specific details, or with other methods or elements without departing from the scope of the claimed subject matter.

Reference throughout this specification to “one embodiment” or “an embodiment” means that a particular feature, structure, or characteristic described in connection with the embodiment is included in at least one embodiment of the present claimed subject matter. Thus, the appearances of the phrases “in one embodiment” or “in an embodiment” in various places throughout this specification are not necessarily all referring to the same embodiment. Furthermore, the particular features, elements, structures, or characteristics may be combined in any suitable manner in one or more embodiments.

Additionally, embodiments of the claimed subject matter may be partially or fully implemented using a computer program product with instructions transferred from a remote computer such as a server over the internet. They may be used in any client/server environment implemented within multiple network architectures such as the World Wide Web.

Overview of the Matched Pairs Private Equity Investment Ltd. (“MPX”)

The embodiments described herein can be implemented through the use of a matched-pairs private equity fund, hereinafter referred to as the MPX fund. A MPX fund administrator may be made up of one or more natural individuals or entities. More than one MPX fund administrators may also administrate a single MPX fund. In one embodiment, the administrator of the MPX fund is made up of an administrator body or a commercial operations advisory committee. In this embodiment, seven natural persons (or members) make up the operations advisory committee, with each member having a level of experience with one or more companies, with each company domiciled in one or more counties, such as China or the United States.

The members may also have past working relationships with one or more of these companies and the members themselves can be selected from groups of persons with many years of corporate management experience, technology or science experience, or any other type of appropriate experience. The following are definitions of various other elements involved with the MPX fund: A recipient corporation is a corporation receiving capital funds from the MPX fund. An investor is a person or entity, or one or more persons and/or entities, whom invests into a MPX fund. An agreement is a limited partnership agreement between one or more investors and the MPX Fund. Capital Contributions are the amounts of cash and the fair value of other property, if any, contributed by the investors to the Fund. The MPX Fund or the Fund is a financial based fund formed by the Limited Partnership Agreement and managed pursuant to the Agreement. An Invested Capital Account is one or more accounts established for each Limited Partner which consist of the total amount contributed to the Fund by each Limited Partner reduced by the amount of money distributed to such Limited Partner by the Fund. The Invested Capital Account is not affected by allocations of profits and losses. An Administrator (also known as a Fund Manager or a General Partner) is one or more entities and each successor, if any, who becomes responsible for the management of the Fund as provided in the Limited Partnership Agreement.

A Limited Partner (also referred to as an “Industry-Capital Partner”) is one or more qualified persons, companies, trusts, pension plans, or other entities which commit to make contributions to the Fund and which shall be, admitted to the Fund as its Limited Partners. Limited Partners may be limited to those having assets of at least a minimum amount, for example USD$100,000, USD$1 million, or USD$5 million. The Priority Return is the rate of return of per annum, such as 10%, 14.5% or any other suitable amount, on the average daily balance of the Invested Capital Account of a Limited Partner during the period to which the Priority Return relates, compounded annually, beginning on the date a Limited Partner contributes capital to the Fund. A Region is one or more geographical and political jurisdictions in which the fund invests, for example Asia or more specifically, The People's Republic of China.

A Unit is an amount representing a commitment to contribute a monetary amount, such as USD $10,000 or USD $100,000 in multiples of 10, which is transferred to the capital belonging to the Fund. Each Unit represents a proportionate interest in the Fund, including economic interests, rights to vote and participate in certain management decisions reserved to the Limited Partners, and all rights to information concerning the business and affairs of the Fund, except as expressly provided in the Agreement.

An Advisory Board is two or more individuals, as selected by the Management or by other parties designated in the Agreement, to serve from time to time as advisors on investments and other matters. An LP Advisory Committee is comprised of four of the large investors plus at least one designee at large from all of the other investors. Fund Manager Capital Contributions are contributions by the Fund Manager which equal an amount, for example 1.0% or 1.5%, of the total subscribed commitments to the Fund.

The Management Fees and Expenses are any fees and expenses incurred in conjunction with the management of the Fund. For example, a typical management fee is 2.5% per annum of the total subscribed commitments, but the fee may be less or it may be more than 2.5%. The management fee will cover normal operating expenses relating to developing, making and monitoring of investments, and the fee would include employee salaries, employee benefits, office expenses, travel and entertainment expenses and other office related expenses such as office equipment rental expenses.

In one embodiment, the Fund pays its own legal, accounting, custodial and / or similar costs. In this embodiment, the Fund shall reimburse the Fund Manager for all ordinary and necessary costs and expenses incurred in connection with the formation and organization of the Fund. Any fees earned or attributed to the Fund Manager, in addition to the management fees, can be paid to the Fund and not to the Fund Manager.

The Allocation of Profits and Losses and Distributions is a pro-rata allocation of profits, losses and distributions of capital based on invested capital. In one embodiment, any allocated cash can be distributed completely (100% of the amount of the allocated cash) to the Limited Partners until the return of all invested capital is accomplished along with an additional return on the invested capital equal to ten percent (10%) per annum based upon the average daily balance of the Invested Capital Account of each Limited Partner, which can also be from time-to-time during the period to which the Priority Return relates, compounded annually, commencing on the date each such Limited Partner contributes capital to the Fund, plus an amount equal to all Management fees previously paid to the Fund Manager. Thereafter, the Fund Manager would receive a 20% carried interest.

The Withdrawal and Transfer of Partnership occurs when certain conditions are met in the Agreement. In one embodiment, Participating Limited Partners may not withdraw from the Fund except in limited circumstances to comply with laws or regulations specifically applicable to that Limited Partner. A Limited Partner may not sell, transfer or assign its interest in any particular Fund except with the consent of the Fund Manager.

In the present embodiments, the liability of the Limited Partnership is also limited. The Limited Partners will not be liable for any obligations of the Fund except that they will be obligated to make their committed capital contributions.

In one embodiment, Units of the Fund are not required to be registered under the Securities Act of 1933, nor are the Units required to be registered under any state securities laws under the provision of exempt transactions not involving a public offering. Because of the non registration, the Limited Partners will be required to make certain representations including, but not limited to, (1) that they are acquiring an interest in the Fund for their own account, (2) that they have received or had access to all information they deem relevant to evaluate the merits and risks of making the investment, (3) that they have the ability to bear the economic risk of an investment in the Fund, and (4) that before any offers are accepted, each prospective Limited Partner will be furnished with a copy of the Limited Partnership Agreement. In addition, the securities related to the one or more funds may be registered with any suitable jurisdiction. For example, they may be registered under the Securities Investment Laws and Regulations of England and Scotland subject to any restrictions applicable to Non-Resident United Kingdom Corporations with Non- United Kingdom Passport holders residing outside the United Kingdom. Candidate “Invested-Partners” are prospective investors subject to one or more securities regulations.

In one embodiment, investment opportunities are solicited to potential investors in blocks, such as those in amounts of 750,000USD or 2,500,000USD or any other suitable denomination. Target investors include European bank portfolio managers, industry or capital partner companies, institutional investors, and sovereign governments' central banks and state owned enterprises. The investors may be restricted in one or more ways. For instance, investors may not be permitted to swap or trade in recipient corporation equities. The investors also may not be permitted to directly or indirectly invest in or loan to a recipient corporation, other than through the MPX fund, and the may not buy or sell recipient corporation's listed equities. Further they may not share, release, or otherwise disseminate any insider information

In this embodiment, companies from the countries of Switzerland, China and The United States are selected to be involved in participating for the MPX fund. Since China is presently an expanding market, the companies selected to be recipient companies will have a great need for working capital. The administrator of the MPX fund initially selects one or more “Industry-Capital Partners,” entities such as corporations that are interested in starting or expanding development in one or more foreign countries. These “Industry-Capital Partners” may have been selected because they have business operations which, by the nature of their business' compatibilities, have the potential to compliment the business operations of one or more of the matched recipient companies that the MPX fund will be invested in.

The MPX fund administrator will be in possession of fully detailed day to day internal operation information for each recipient corporation and this information may also be independently verified by one or more third parties. This can include all of the substantive decisions and actions of the board of directors and executives of the recipient corporation. The administrator may also provide guidance and information as to control methods, procedures, and other related services to each of the recipient corporations. The resulting monitoring and cooperation between the three parties increases the efficiency of the operations. Additional consideration may also be provided as further incentive for reaching milestones or other purposes. The resulting effects accrue to the benefit of the investors, and the bi-national operations to become completely integrated and unified in their tactical and strategic purposes.

The administrator may perform various other functions such as “hand-holding” or closely assisting the recipient corporation through a portion or all of the way through the matched pair funding process until a suitable history is established. An established history of a range of share prices may allow outside confirmation by the investment community that the installed and operational embodiment of the present invention has generated the desired effects and that those effects will have staying power.

It should also be noted that embodiments of the present methods and systems may enable lower investment risk profiles than what would normally be found as the industry-standard risk profiles.

In one embodiment involving two film production companies will now be described. Shanghai and many other vibrant China marketplaces such as Zhu Hai, Macau, Shenzhen, and Hong Kong are undergoing a vast economic expansion. With this expansion, working capital needed by small and medium sized Chinese companies has become more difficult to acquire. Foreign investors have been reluctant to invest in Chinese companies for a number of reasons. For example, the Rule-Of-Law situation in China has contributed to the uncertainty of investors because in the past, one was unable to be certain that a legal contract, having been properly signed, was fully enforceable at any given time.

Many hundreds of small and medium sized Chinese companies are receiving large increases in orders for export products, while at the same time they are unable to raise sufficient expansion capital to support those orders. Opportunities for investment capital are difficult to obtain when a Chinese company is isolated, and many will not have a chance to somehow get their corporations listed on a national or foreign stock exchange. These exchanges include the NASDAQ, the AIM, the Euronext, the AMEX, the DAX, the SWISS, the Milan as well as any other suitable public share exchange.

In one embodiment, multiple China based film production companies are experiencing rapid growth and are in need of capital to continue growing as well as to accelerate that growth. The China film production companies are matched with film production companies in the United States having access to the capital markets. Investors invest funds and capital into the MPX fund which in turn invests an amount, such as USD$ 8 million or USD $10 million or any other suitable amount, into the China based film production company.

While the inventive subject matter has been described with reference to multiple embodiments, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead the claimed subject matter includes all possible embodiments falling within the scope of the appended claims.

What is claimed is:

1. A method of pairing investment capital with entities in need of capital comprising the steps of:
locating and establishing a relationship with a suitable paired growth company in need of capital;
locating and establishing a relationship with a paired publicly traded company with available capital;
establishing a fund for investing capital into the paired growth companies in need of capital;
investing capital from the fund into the paired growth company;
receiving equity from the paired growth company in exchange for the capital; and
holding in the fund an amount of the received equity in one or more freely tradeable shares of the paired publicly traded company which are listed on a public stock exchange;
wherein the publicly traded company is paired with the paired growth company so that the paired growth company has access to the capital markets through the shares of the publicly traded company which are listed on one or more public exchanges.

2. The method of claim 1 further comprising the step of merging the paired publicly traded company with the paired growth company into a single entity with shares listed on one or more public exchanges.

3. The method of claim 1 further comprising the step of managing the business relationship between the paired publicly traded company and the paired growth company so that the efficiencies of the tactical legal and economic relationships between maximized.

4. The method of claim 1 wherein the investment is further adjusted by the appreciation or depreciation of one or more foreign currencies.

5. The method of claim 1 wherein the investment is further adjusted by the appreciation or depreciation of the value of the one or more equity stocks.

6. A system of matching investment capital with entities in need of capital comprising the steps of:
locating and establishing a relationship with a suitable paired growth company in need of capital;
locating and establishing a relationship with a paired publicly traded company with available capital;
establishing a fund for investing capital into the paired growth companies in need of capital;
investing capital from the fund into the paired growth company;
receiving equity from the paired growth company in exchange for the capital; and
holding in the fund an amount of the received equity in one or more freely tradeable shares of the paired publicly traded company which are listed on a public stock exchange;
wherein the publicly traded company is paired with the paired growth company so that the paired growth company has access to the capital markets through the shares of the publicly traded company which are listed on one or more public exchanges.

7. The system of claim 6 wherein further comprising the step of merging the paired publicly traded company with the paired growth company into a single entity with shares listed on one or more public exchanges.

8. The system of claim 6 further comprising the step of managing the business relationship between the paired publicly traded company and the paired growth company so that the efficiencies of the tactical legal and economic relationships between maximized.

9. The system of claim 6 wherein the investment is further adjusted by the appreciation or depreciation of one or more foreign currencies.

10. The system of claim 6 wherein the investment is further adjusted by the appreciation or depreciation of the value of the one or more equity stocks.
